(19) United States
(12) Patent Application Publication
(10) Pub. No.: US 2006/0213829 A1
(43) Pub. Date: Sep. 28, 2006

(54) Production of submicron diameter fibers by two-fluid electrospinning process

(76) Inventors: Gregory C. Rutledge, Newton, MA (US); Jian H. Yu, Cambridge, MA (US); Sergey V. Fridrikh, Acton, MA (US)

Correspondence Address: Jacobs Patent Office, P.O. Box 390438, Cambridge, MA, 02139, US

(21) Appl. No.: 11/089,931

(22) Filed: Mar. 25, 2005

(51) Int. Cl. B01D 24/00; B01D 39/00

(52) U.S. Cl. 210/503; 210/505; 264/41

(57) ABSTRACT

Electrospinning of materials that are difficult or impossible to process into nanofibers by conventional fiber-forming techniques or by electrospinning are prepared by an electrospinning procedure which uses an electrospinnable outer “shell” fluid around an inner “core” fluid, which may or may not be electrospinnable, to form nanofibers of the inner core fluid having a core/shell morphology. The resulting shell around the nanofiber can remain in place or be removed during post-processing with the core of the fiber remaining intact. The dual-fluid electrospinning process can produce core fibers having diameters less than 100 nm, insulated nanowires, as well as tough, bio-compatible silk fibers. Alternatively, the core can be removed leaving a hollow fiber of the shell fluid.

### U.S. GOVERNMENT INTERESTS

This invention was made with U.S. government support under a co-operative agreement awarded by the U.S. Army. The U.S. government may have certain rights to the invention.

### BACKGROUND OF THE INVENTION

Electrostatic fiber formation, or “electrospinning” is a process that employs electrostatic forces to produce fibers with diameters ranging from microns down to tens of nanometers—two to three orders of magnitude smaller than those produced by conventional fiber spinning methods. While electrospinning of fibers first occurred in the 1930's (U.S. Pat. No. 2,077,373) (1934), the process has only recently attracted greater attention due to its simplicity in making nanofibers from both synthetic and natural polymers.

Electrospinning itself is quite general. Despite the fact that over 30 different polymers have been electrospun in batch or continuous mode to produce fibers with diameters below 1 micron, there are still many fluids that cannot be electrospun or are very difficult to electrospin. The present invention expands the use of electrospinning to these fluids. Numerous, diverse applications for electrospun fibers have been proposed. These include: bio-degradable electrospun non-woven fabrics for use in tissue engineering and in drug delivery; high surface area fabrics for use in protective clothing and sensors; and highly efficient filtration membranes based on small inter-fiber distances combined with low pressure drop. Also electrospun fibers have been post-treated to produce ceramic and metallic nanofibers. Despite the encouraging results of electrospun fibers, routine production of uniform fibers with diameters less than 500 nm, preferably less than 100 nm, along the entire length of the fiber is still a challenge, particularly from those fluids that are not readily electrospinnable.

Electrospinning itself has been problematic because some of the spinnable fluids are very viscous and require higher forces than electric fields can supply before sparking occurs, i.e., there is a dielectric breakdown in the air. Other fluids, particularly those which have been diluted in an attempt to produce fibers having diameters in the namometer range, are often found to be so dilute that jets break up into a spray of drops, precluding continuous fiber formation. Likewise, the techniques have been problematic when higher temperatures are required because the higher temperatures increase the conductivity of structural parts and complicate the control of high electrical fields.

Heretofore, two major strategies to decrease fiber diameter have generally been employed. The first has entailed reducing the concentration of polymer in the spin solution, thereby relying on solvent removal to produce a residual solid fiber of a smaller diameter. This approach suffers from low productivity (the majority of the spun fluid is a sacrificial solvent) and high solvent handling issues as well as droplet formation. The second approach has been to increase the charge-carrying capacity of the fluid through addition of suitable, usually non-polymeric, additives. The additive approach has led to suppression of the Rayleigh instability and enhancement of the whipping instability, thereby leading to dramatic stretching and thinning of the fluid jet. The production of smaller fibers can be understood in terms of a limiting jet diameter which results from this stretching process has been confirmed experimentally using polycaprolactone solutions with varying levels of induced charge. For example, when palladium(II) diacetate was added to a solution of poly(L-lactide) in dichloromethane to increase its conductivity and charge density, the fiber diameter was reduced to 5 nanometers.

In numerous cases, however, polymers that are of the most current interest as materials to form nanofibers cannot be electrospun to form fibers at all. Such fibers are referred to hereafter as “non-electrospinnable” while those fluids that readily form uniform, continuous fibers are “electrospinnable.” Common problems limiting electrospinnability of a polymer include poor solubility, limitations on available molecular weights, and unusually rigid or compact (“globular”) molecular conformations. These limitations are sometimes interpreted using a metric based on the Berry Number, which is defined as the product of intrinsic viscosity [η] and concentration. The Berry Number provides a qualitative indication of cross-over into a semi-dilute solution regime, where entanglements between chains may become effective. More precisely, some degree of elasticity is required, in the absence of which electrospun fluids generally do not form uniform fibers. Instead, droplets or “beads-on-strings” are formed.

Although there are previous reports of pure silk fibers electrospun from solutions, they have been in non-aqueous solvents like hexafluoro-2-isopropanol and formic acid (see Zarkoob et al, Pollymer 2004, 45, 3973; Sukigara et al, Polymer 2003, 44, 5721), where solubility is not a problem. Water is a more benign solvent, but silk is not as soluble in water so that the concentration cannot be made high enough to form a spinnable solution of silk in water. One attempt to overcome the “spinnability” problem with aqueous solutions of silk has been to add a miscible high molecular weight polyethylene oxide (PEO) polymer to the solution. The added component, being itself electro-spinnable, rendered the silk/PEO mixture electrospinnable. However, the resultant fiber is a silk-PEO blend, not pure silk. The 2-fluid process of this invention allows the formation of pure silk fibers for the first time from an aqueous solution.

A similar strategy to provide electrospinnability to a polymer has entailed adding PEO to polyaniline (Pani) and electrospinning the mixture into fibers. The result has been fiber blends wherein the fibers have had compromised properties, such as mechanical integrity, conductivity, and biocompatibility. Attempts to remove the PEO portion of the fiber blends by post-processing (extraction) have not been successful, resulting in undesirable fiber properties after extraction.

U.S. Pat. Nos. 6,382,526, 6,520,425 and 6,695,992 disclose process and apparatus for forming a non-woven mat of nanofibers by using a pressurized gas stream. The process entails feeding a fiber-forming material into an annular column, the column having an exit orifice, directing the fiber-forming material into a gas jet space, thereby forming an annular film of fiber-forming material, the annular film having an inner circumference, simultaneously forcing gas through a gas column concentrically positioned within the annular column, and into the gas jet space, thereby causing the gas to contact the inner circumference of the annular film. The resulting fiber-forming material ejects from the exit orifice of the annular column in the form of a plurality of strands of fiber-forming material that solidify and form nanofibers having large diameters, often as much as about 3,000 nanometers.

The present invention overcomes the aforementioned problems.

### BRIEF DESCRIPTION OF THE DRAWINGS

FIG. 1 is a schematic drawing of a two-fluid electrospinneret in accordance with the present invention.

FIG. 2A is an external view of the two-fluid electrospinneret used in the Examples below. FIG. 2B is an external view of the two fluid electrospinneret of FIG. 2A prior to complete assembly.

FIG. 3A is an SEM image of the core-shell fiber of Example 1; FIG. 3B is an axial TEM view of the fiber of Example 1; FIG. 3C is a lateral TEM view of the fiber of Example 1.

FIG. 4A is an SEM image of the 8 wt % polyacrylonitrile (PAN) core fiber of Example 1 prior to removal of its polyacrylonitrile-co-polystyrene (PAN-co-PS) shell; FIGS. 4B, C, and D are SEM images of fibers prepared from 5, and 3 wt % PAN, respectively, prepared in accordance with this invention, shown after removal of the PAN-co-PS shell.

FIGS. 5A, B, and C are SEM images of polyacrylonitrile polymer fibers containing respectively 8, 5, and 3 wt % polyacrylonitrile, but prepared in accordance with Comparative Example A by a single fluid electrospinning procedure, i.e. in the absence on a shell fluid.

FIG. 6A is an SEM image of silk core/polyethylene oxide (PEO) shell fibers; FIG. 6B is the fiber mat of FIG. 6A after being soaked in methanol before removing the PEO in water; and FIG. 6C is a TEM image showing that the core/shell fiber of FIG. 6A has a thin PEO shell.

### SUMMARY OF THE INVENTION

The present invention is directed to substantially continuous fibers which as prepared have a core-and-shell structure. The fibers may be further process to remove either the shell or the core. The core fibers have a uniform diameter of less than about 1 micron, preferably generally less than about 500 nm, and most preferably less than about 100 nm. The invention is further directed to a process to for manufacture of the fibers. The fluid used to form the shell is an electrospinnable fluid. The fluid used to form the core fiber can be electrospinnable, but preferably it is either not electrospinnable at all or is very hard to process using conventional single fluid spinning methods.

The fibers are formed by use of a two-fluid electrospinneret to make fibers with a shell-and-core structure. The shell fluid can serve as a process aid for the core fluid. The core of the fibers can optionally be exposed by removal of the shell material in a post-treatment. The shell of the fibers can optionally be formed into hollow fibers by removal of the core material in a post-treatment. The final morphology of the fibers can be modified by controlling processing parameters (rates, voltage, current, etc.) and fluid properties (conductivity, viscosity, etc.). Complex electro-hydrodynamics are involved in the two-fluid electrospinning.

The fibers produced by the two-fluid electrospinning process have a broad range of applications. Use of the shell-core system extends the range of concentrations and molecular weights of polymers that can be electrospun into fibers. Thus finer fibers are possible than heretofore and new materials can now be processed.

Either the core or shell fluids can be doped with additives. For example, the core fluid can carry a drug while the shell served as a thin barrier for controlled, long-term release. Alternatively, the shell fluid can carry surface active agents such as biocides, chemical agent neutralizers, or coagulants, while the core provides structural support and longevity.

### DESCRIPTION OF THE PREFERRED EMBODIMENTS

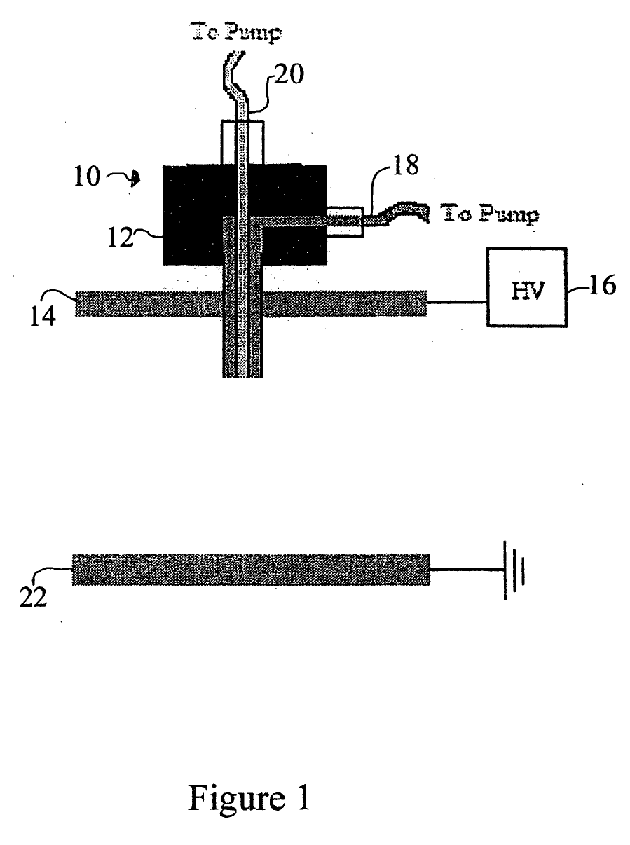

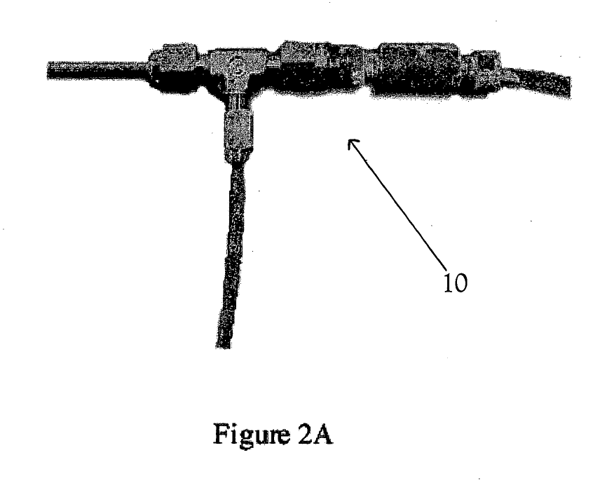

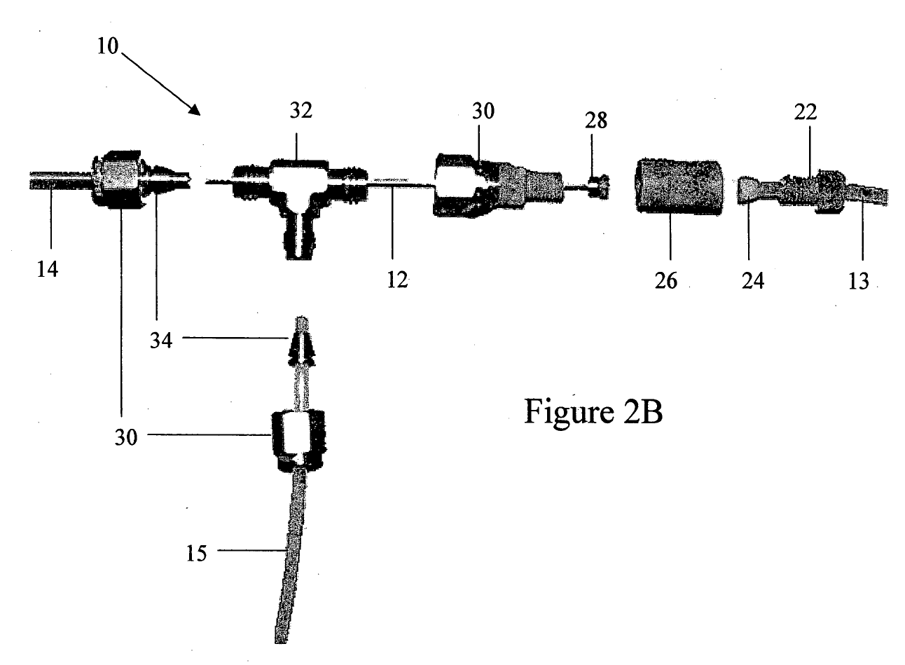

This invention is directed to the preparation of electrospun fibers from difficult-to-process fluids and of fibers with smaller diameters and core-shell structure. The process utilizes an electrospinneret as shown in FIGS. 1 and 2 that allows for co-axial extrusion of two fluids. The housing of the electrospinneret 10 consists of a concentric inner tube 12 and outer tube 14 by which two fluids are introduced to the spinneret, one (hereafter denoted the “core fluid”) in the core of the inner tube 12 and the other (hereafter denoted the “shell fluid”) in the annular space between the inner tube 12 and the outer tube 14. The electro-spinneret is designed to keep the fluids separate as they are charged via a high energy source 16 and emitted from a nozzle 20.

The materials of construction are chosen such that either one or both of the fluids may be charged by contact with a high voltage as the fluid passes through the spinneret. In the examples below the spinneret shown in FIG. 2 was used in a parallel plate equipment configuration. The spinneret has two generally steel tubes so that both fluids were charged simultaneously to the same potential. In the specific device shown, the inner tube 12 having an i.d. of 0.46 mm and an o.d. of 0.79 mm if fed through feedline 13, while the outer tube 14 has an i.d. of 2.03 mm and an o.d. of 3.18 mm and is fed through feedline 15. The core feedline 13 leads to a PEEK ferrule 22 which is attached to a PEEK O-ring 24 which connects into PEEK connector 26. The opposite end of PEEK connector 26 connects to a PEEK ferrule and steel cap 30 by an adhesive O-ring 28. The core side steel cap connects to one leg of a steel T-tubing connector 32 in the in-line direction with core tube 12 extending through the center thereof. The side leg of the T-tubing connector 32 connects to shell feedline 15 by means of ferrule 34 and steel cap 30. The core tube 12 and shell tube 14 jointly exit the T-tubing connector 32 as a concentric tube assembly through a further steel cap 30 and ferrule 34. The concentric tube assembly protrudes from the center of a top disk (not shown in FIG. 2) by an adjustable amount. A second disk (as seen in FIG. 1) was used as a collector by connecting it to the ground. The disks were made of aluminum and were 12 cm in diameter, separated by a distance up to 45 cm, though other materials, sizes and distances may be used.

Other equipment configurations, such as those involving a moving collector wheel or belt, may also be used.

To be able to function as a processing aid for the core material, the shell fluid must be an electrospinnable fluid. The core fluid, on the other hand, does not need to be an electrospinnable fluid. Preferably, in fact, the core fluid does not, on its own, readily form a fiber by electrospinning. During electrospinning, the shell fluid forms a sheath around the core fluid, which stabilizes it against break-up into droplets by a process such as Rayleigh instability.

Stabilization based on the introduction of a shell fluid is believed to operate through two mechanisms. (1) By replacing the normal exterior fluid (typically air or vacuum in conventional single-fluid electrospinning) with a viscoelastic medium, the Rayleigh instability in the core fluid can be delayed or suppressed completely; when the exterior fluid is furthermore spun as a shell fluid, as described here, stretching of the shell component imparts greater elasticity to the interface, i.e. strain hardening, further stabilizing the core fluid. (2) The shell fluid also reduces the very surface forces at the boundary of the core fluid which drive the break-up of the core fluid into droplets by replacing the relatively high fluid-vapor surface tension typically present in single-fluid electrospin-ning by a lower fluid-fluid interfacial tension.

During the electrospinning, the fluids can travel at speeds of tens of meters per second upon exiting the nozzle. The two fluids may or may not be miscible. However, the short time duration of the process prevents the two fluids from mixing significantly. The use of a common solvent for the two fluids favors a particularly low interfacial tension. In the case of polymer solutions, the polymers must not precipitate at the fluid interface near the nozzle.

Generally suitable and currently preferred operating conditions are given in Table I. Specific operating conditions for particular compositions can be readily determined via trial and error.

TABLE I

| OPERATING PARAMETER | GENERAL | PREFERRED |
|---|---|---|
| Voltage range, kV | 1 to 100 | 5 to 30 |
| Distance to collector, cm | 10 to 100 | 20 to 40 |
| Core fluid flow rate, ml/min | 0.001 to 0.01 | 0.001 to 0.005 |
| Shell fluid flow rate, ml/min | 0.01 to 1 | 0.02 to 0.1 |
| Fluid viscosity, Pa · s | 0.01 to 100 | 0.1 to 10 |
| Fluid conductivity, μS/cm | at least 0.01 | 0.5 to 100 |
| Concentrations by mass, wt % | at least 0.1 | 3 to 30 |
| Fluid surface tension, N/m | 0.01 to 0.2 | 0.023 to 0.08 |
| Continuous fiber diameter | 1 nm to 1 micron | 50 to 400 nm |

One important core polymer fiber that can be prepared in accordance with the present invention is silk. Previous silk fibers have been blends of silk and a hydrophillic polymer such as polyethylene oxide while the present silk polymer fibers do not contain any additive to make the silk spinnable. Rather silk is used in the core of a core-and-shell fiber within a shell of an electrospinnable composition. Suitable operating parameters for producing the silk fibers are quite similar to the parameters given in Table I. The core fluid and shell fluid flow rates are comparable for both systems. Somewhat lower field strengths are recommended for the silk systems—about 0.4 kV/cm as compared to about 1 kV/cm—because of differences in characteristics, e.g. concentration and molecular weights, of the polymers and solvents used. The fluids (silk or otherwise) need to have solution properties (viscosity, conductivity, and surface tension) within the general ranges specified above. All fluids are solutions of polymer in solvent. If the molecular weight of polymer is low, then the concentration needs to be increased to get the desired fluid properties.

The two-fluid electrospinning process of the present invention may be used to form core fibers from any polymer solution having the fluid properties specified herein. While the process can produce fibers from essentially any polymer, it is most noteworthy for being able to form fibers from polymers that are not readily spinnable on their own. Suitable polymers generally are those having a low molecular weight or form dilute solutions because either of these characteristics can render a polymer unspinnable.

Silk is one of the polymers that is of particular importance. It is poorly soluble in water even with added salts. Silk has application in mechanical reinforcement (e.g. composites, cables); other polymers that compete with it in that application include Kevlar, Nomex (both aramids) and polyurethanes (e.g. Elastane). The aramids are also only sparingly soluble. Other polymers that are useful as biomaterials are natural polymers (collagen, fibrin, elastin, most of which are only sparingly soluble) and degradable polymers like polyhydroxyalkanoates (e.g. polycaprolactone, polylactic acid, polyglycolic acid, and copolymers of these). Polyanilinesulfonic acid is useful to make conductive fibers (“wires”), and is another example of a difficult to dissolve material that is hard to spin on its own.

In the non-limiting Examples below, all parts and percents are by weight unless otherwise specified.

To demonstrate the usefulness of this invention for making fibers, three prototypical core/shell systems were used: PAN/PAN-co-PS (Examples 1-2), Pani/PVA (Example 3), and silk/PEO (Example 4). Specific processing conditions are detailed in the Examples. Each of the solutions was delivered to a two-fluid electrospinneret as a core or shell fluid at appropriate flow rates to keep the core-shell jet continuous. The voltage applied to the spinneret was sufficiently low that the electrical force did not pull the fluids too fast or too slow at the nozzle. If the core fluid flow rate is set too high, the core fluid jet breaks into droplets. If the shell fluid flow rate is set too high, shell fibers form without a continuous thread of the core material. During steady operation, concentric Taylor cones formed by the two fluids are observable.

The present invention is based in part upon the discovery that proper choice of a miscible fluid, even when using a common solvent, can serve to reduce the interfacial tension on the core stream, allowing production of smaller diameter fluids and even fibers from non-electrospinnable fluids.

The resulting fibers were examined by taking fiber images using electron microscopes. The fibers were coated with a 10 nm layer of gold for SEM imaging. A SEM (JOEL SEM 6320) instrument was used to observe the general features of the fibers. A TEM (JOEL 200CX) instrument was used to observe the core-shell structure of the fibers. For the TEM lateral view, fibers were deposited directly onto a copper TEM grid. For the TEM axial view of PAN/PAN-co-PS fibers, they were first fixed in epoxy and then ultramicrotomed to cut 100 nm slices. Chloroform was used to remove the PAN-co-PS shell from PAN/PAN-co-PS fibers.

### EXAMPLE 1

A two-fluid electrospinneret as shown in FIG. 2 was used to prepare a nanofiber having a core of polyacrylonitrile (PAN), which is of particular interest as a precursor to carbon nanofibers. PAN (MW 150,000) was dissolved in N,N-dimethylformamide (DMF) to form an 8 wt % solution. The fluid used for the outer shell layer was 20 wt % polyacrylonitrile-co-polystyrene (PAN-co-PS) (MW 165,000) dissolved in N,N-dimethylformamide.

The two fluids were processed through the electrospinneret at a voltage of 26 kV and using a disk separation of 40 cm. The PAN had a flow rate of 0.008 ml/min. The PAN-co-PS had a flow rate of 0.07 ml/min.

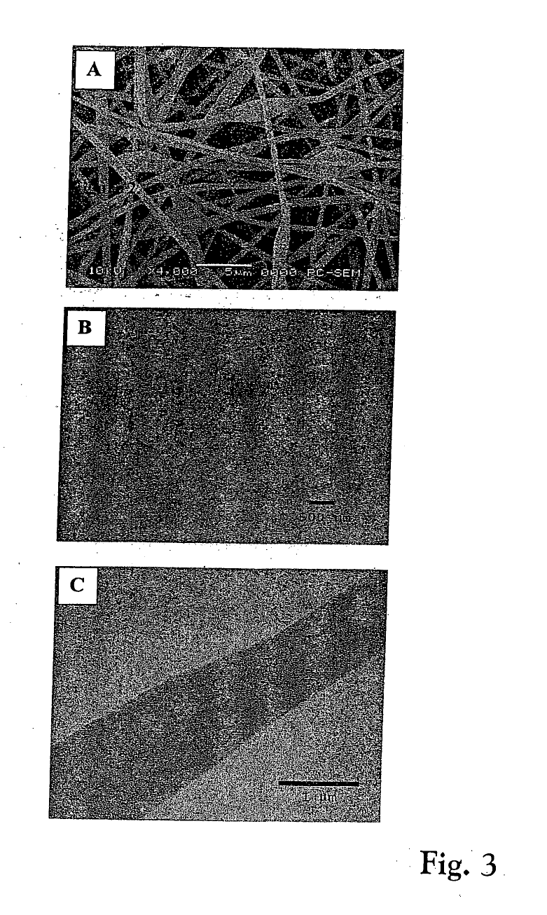

FIG. 3A is an SEM image of the resultant core-shell fiber produced. FIGS. 3B and 3C are axial and lateral TEM views of the fiber.

Although the formation of PAN fibers with diameters of 50 nm have been reported in the literature, the overall size distribution in that case was bimodal, with average diameters around 100 nm and 200 nm. The fiber size distribution can be made more narrow, and the fibers more uniform, by increasing the PAN concentration, but it causes the fiber size to increase. In less concentrated PAN solutions the Rayleigh instability dominates and prevents formation of fibers.

### EXAMPLE 2

The procedure of Example 1 was repeated to produce additional PAN fibers at varying polymer concentrations. The concentrations and electrospinning conditions used were:

| | | | |
|---|---|---|---|
| Systems | 1 | 2 | 3 |
| Voltage | 26 kV | 28 kV | 30 kV |
| Disk | 40 cm | 40 cm | 35 cm |
| Separation | | | |
| Core-fluid | 8% wt | 5% wt | 3% wt |
| | Polyacrylonitrile | Polyacrylonitrile | Polyacrylonitrile |
| | (PAN) | (PAN) | (PAN) |
| | Mw 150,000 | Mw 150,000 | Mw 150,000 |
| | in N,N-dimethyl- | in N,N-dimethyl- | in N,N-dimethyl- |
| | formamide | formamide | formamide |
| | (DMF) | (DMF) | (DMF) |
| Flow rate | 0.008 ml/min | 0.008 ml/min | 0.002 ml/min |
| Shell-fluid | 20% wt | 25% wt | 28% wt |
| | Polyacrylonitrile- | Polyacrylonitrile- | Polyacrylonitrile- |
| | co-Polystyrene | co-Polystyrene | co-Polystyrene |
| | (PAN-co-PS) | (PAN-co-PS) | (PAN-co-PS) |
| | 25% wt | 25% wt | 25% wt |
| | acrylonitrile | acrylonitrile | acrylonitrile |
| | Mw 165,000 | Mw 165,000 | Mw 165,000 |
| | in DMF | in DMF | in DMF |
| Flow rate | 0.07 ml/min | 0.07 ml/min | 0.04 ml/min |

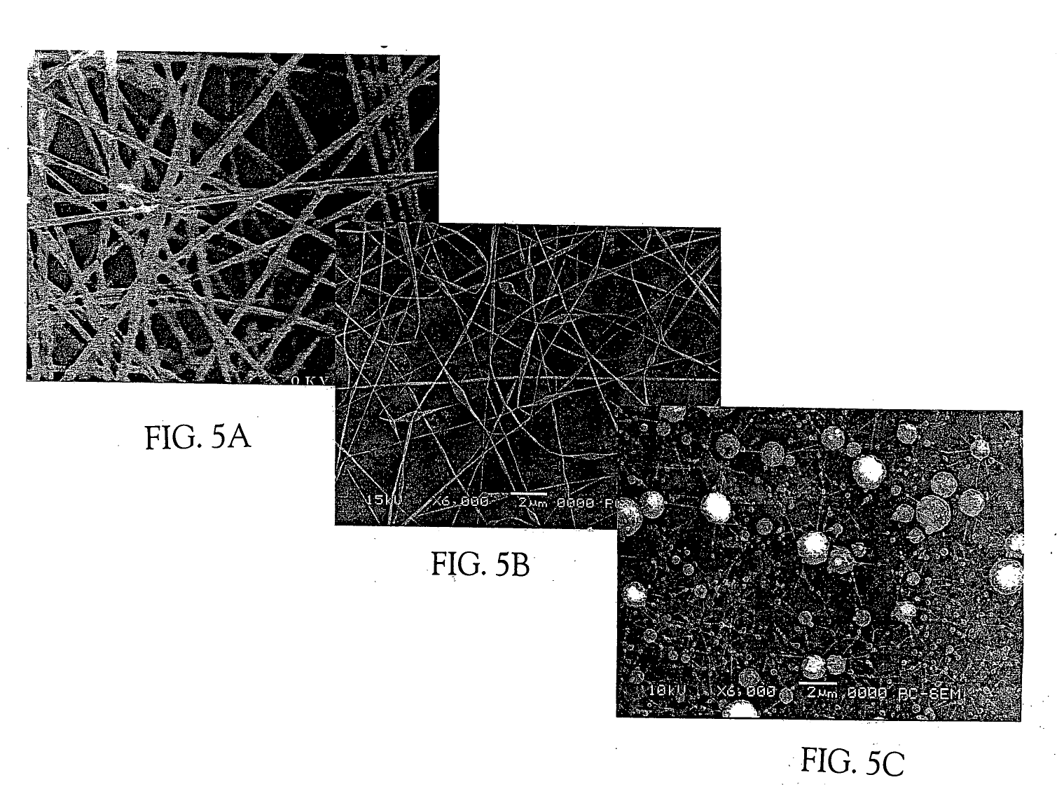

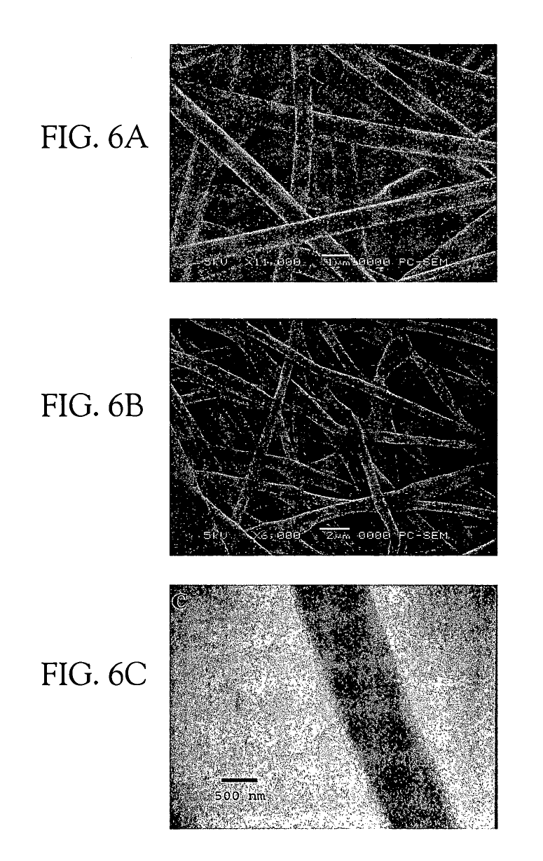

FIG. 5A is the SEM image of an 8 wt % polyacrylonitrile (PAN) core fiber before removal of its polyacrylonitrile-co-polystyrene (PAN-co-PS) shell. The average fiber diameter was about 500 nm.

FIGS. 5B, C, and D are SEM's of the 3 fibers after the removal of the shell material (PAN-co-PS) by dissolving in chloroform. As can be seen, the residual PAN fibers prepared by the 2-fluid process were all found to be quite uniform.

Uniform fibers were obtainable from the 5 and 3 wt % concentrations by two-fluid electrospinning, with the presence of the shell polymer in fluid, as shown in Example 2 above. The increase in the mass concentration of the shell fluid was useful to suppress further the Rayleigh instability in the 3 wt % PAN core fluid. Fibers recovered after the removal of the shell had average diameters of 105 nm (s.d. 25) and 65 nm (s.d. 15) from the 5 wt % and 3 wt % PAN solutions, respectively, and were unimodal in distribution (FIGS. 5C and 5D).

### COMPARATIVE EXAMPLE A

The three polyacrylonitrile (PAN) solutions of Example 2 were sub-jected to electrospinning conditions using the spinneret of FIG. 2, but in the absence of a shell fluid.

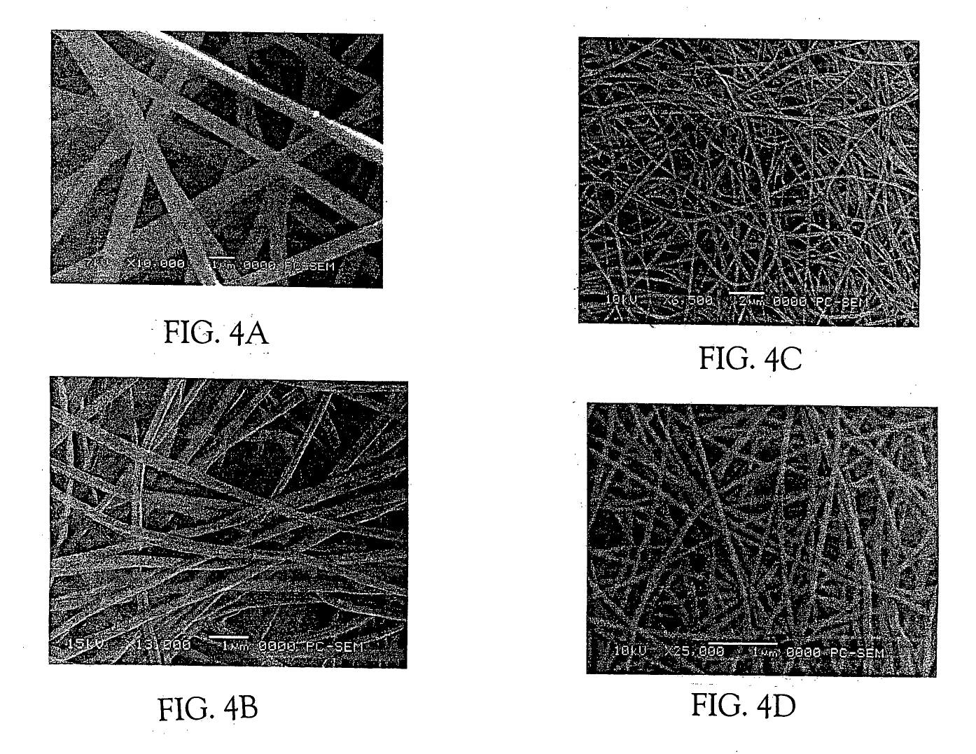

The resulting products were examined by SEM and the results are shown in FIGS. 4A, B, and C, respectively for the 8, 5, and 3 wt % PAN products.

The 5 wt % PAN solution in DMF, when electrospun in single-fluid mode, formed heavily beaded non-uniform fibers. The 3 wt % PAN solution could not be electrospun into fibers at all, due to break-up of the jet into droplets.

### EXAMPLE 3

Nanofiber polyaniline (PAni) is of an interest for the formation of conducting nanowires, but is difficult to process in part due to low molecular weight and limited solubility in electrospinnable solutions.

Thus the procedure of Example 1 was repeated with a PAni/PVA—polyanilinesulfonic acid/polyvinyl alcohol—core/shell system. The electrospinning conditions and the fluids used were:

| | |
|---|---|
| System | 4 |
| Voltage | 20 kV |
| Disk | 25 cm |
| Separation | |
| Core-fluid | 5% wt Poly(anilinesulfonic acid) |
| | (PAni) in water |
| Flow rate | 0.005 ml/min |
| Shell-fluid | 8% wt Poly(vinyl alcohol) (PVA) |
| | Mw 146,000-86,000; in water |
| Flow rate | 0.01 ml/min |

Examination of the resulting fibers showed that the PAni/PVA fibers had an average diameter of 310 nm. A lateral TEM image showed that the PAni core had a diameter of 120 nm. About a third of the fibers did not exhibit the core/shell structure. PAni is significantly more conductive than PVA, and it is believed that it has a higher volume charge density than PVA solution and thus was pulled by the electric field at a higher rate than the feed line could supply, resulting in a discontinuous stream of PAni solution. When a sufficient amount of PAni solution accumulated at the nozzle, the core/shell structure formed again.

### EXAMPLE 4

Natural silk is a good material for tough biocompatible fibers, but an aquesous solution of it cannot be electrospun because silk is not sufficiently soluble in water to make a solution having an appropriate balance of concentration and viscosity. Moreover, when additives are used to enhance solubility, the resulting aqueous solutions have a tendency to gel at high concentrations.

The procedure of Example 1 was repeated with a Silk/PEO—Bombyx mori silk/polyethylene oxide—core/shell system to produce a pure silk polymer fiber, i.e. not a mixture of silk and a second polymer such as PEO. The electrospinning conditions and the specific fluids used were:

| | |
|---|---|
| System | 5 |
| Voltage | 9 kV |
| Disk | 37 cm |
| Separation | |
| Core-fluid | 8 wt % Bombyx mori silk in water |
| Flow rate | 0.0075 ml/min |
| Shell-fluid | 8 wt % Poly(ethylene oxide) (PEO) |
| | Mw 1,500,000; in water |
| Flow rate | 0.01 ml/min |

The resultant continuous silk/PEO core/shell fibers had an average diameter of 800 nm and when viewed by SEM were uniform. The average diameter decreased to about 600 nm after removal of the PEO shell and the pure silk core fibers appeared slightly non-uniform in diameter. The lateral TEM image confirmed that the PEO shell was thinner than the silk core. The non-uniformity of these pure silk core fibers was probably due to the high gelation rate of the silk solution causing some non-uniformity in its elastic properties. The aqueous silk solution was very unstable; small disturbances or additions of foreign particles set off immediate gelation. While the shell-fluid was still stretching in flight, gelation prevented the core from further stretching.

The relatively large 600 nm diameter silk fiber diameter is because the purpose of the experiment was to demonstrate the feasibility of preparing a “pure” silk fiber. Fine tuning of the system will produce fibers with smaller diameters. Suitable operating conditions which can be used to produce pure silk fibers are shown in Table II.

TABLE II

| OPERATING PARAMETER | GENERAL | PREFERRED |
|---|---|---|
| Electrical field, kV/cm | 0.2 to 0.45 | 0.3-0.4 |
| Silk (core) fluid flow rate, ml/min | 0.001 to 0.008 | 0.002 to 0.004 |
| PEO (shell) fluid flow rate, ml/min | 0.01 to 0.08 | 0.02 to 0.05 |
| Concentration silk in fluid, wt % | 4 to 10 | 7 to 9 |
| Concentration PEO in fluid, wt % | 1 to 3 | 1.5 to 2.5 |
| PEO avg. molecular weight | 1M to 3M | about 1.5M |
| Fluid surface tension, N/m | 0.01 to 0.2 | 0.023 to 0.08 |
| Continuous fiber diameter, nm | 50 to 1000 | 100 to 800 |

What is claimed is:

1. A substantially continuous electrospun core-and-shell fiber having a core diameter of less than 1 micron along its entire length.

2. The fiber of claim 1, wherein the shell is removed from the core-and-shell fiber.

3. The fiber of claim 2, wherein the core is a polyacrylonitrile fiber having a diameter of less than 100 nm.

4. The fiber of claim 3, wherein the shell is removed from the polyacrylonitrile fiber.

5. The fiber of claim 4, wherein the core polyacrylonitrile fiber after shell removal is pyrolyzed to produce a pure, continuous uniform carbon fiber having a core diameter of less than 100 nm.

6. The fiber of claim 4, wherein the shell is removed by dissolution in chloroform.

7. The fiber of claim 1, wherein the core is removed from the core-and-shell fiber leaving a hollow fiber having a substantially uniform central diameter along its entire length.

8. The fiber of claim 1, wherein the core diameter is less than 500 nm.

9. The fiber of claim 1, wherein the core diameter is less than 100 nm.

10. The fiber of claim 1, wherein the core fiber is silk.

11. The fiber of claim 1, wherein the core fiber comprises polyaniline sulfonic acid and the shell comprises polyvinylalcohol.

12. A fiber mat of a substantially continuous electrospun core-and-shell fiber having a core diameter of less than 1 micron along its entire length, said fiber having been collected on a grounded electrode.

13. A method of preparing a substantially uniform continuous fiber having a core-and-shell structure and a diameter less than 1 micron which comprises electrospinning an electrospinnable polymer solution as a shell around a core fiber solution.

14. The method of claim 13, wherein the core fiber solution is not electrospinnable.

15. The method of claim 13, wherein the core fiber solution is not sufficiently electrospinnable in the absence of an electrospinnable polymer solution shell-forming solution to form a continuous fiber having a uniform diameter.

16. The method of claim 13, wherein the electrospinning is performed at a voltage range of about 1 to about 100 kV and a distance to collector of about 10 to 100 cm.

17. The method of claim 13, wherein the shell fluid has a flow rate of about 0.01 to 1 ml/min and the core fluid has a flow rate of about 0.001 to 0.01 ml/min.

18. The method of claim 13, wherein the shell fluid and the core fluid each have fluid viscosities of about 0.01 to about 100 Pas.

19. The method of claim 13, wherein the shell fluid and the core fluid each have polymer concentrations by mass of at least 0.1 wt %.

20. The method of claim 13, wherein the shell fluid and the core fluid each have a fluid surface tension of about 0.01 to 0.2 N/m.

21. The method of claim 13, wherein the shell fluid and the core fluid each have a fluid conductivity of at least 0.01 μS/cm.

22. The method of claim 13, wherein the core fiber solution forms a continuous nanofiber having a diameter of less than 100 nm along substantially its entire length.
